(19) United States
(12) Patent Application Publication
(10) Pub. No.: US 2025/0260137 A1
(43) Pub. Date: Aug. 14, 2025

(54) BATTERY

(71) Applicant: TOYOTA JIDOSHA KABUSHIKI KAISHA, Toyota-shi (JP)

(72) Inventors: Tsuyoshi EHARA, Toyota-shi (JP); Shigenori HAMA, Okazaki-shi (JP); Hiroshi NAGASE, Nagoya-shi (JP)

(73) Assignee: TOYOTA JIDOSHA KABUSHIKI KAISHA, Toyota-shi (JP)

(21) Appl. No.: 19/042,186

(22) Filed: Jan. 31, 2025

(30) Foreign Application Priority Data
Feb. 9, 2024 (JP) 2024-018706

(51) Int. Cl. H01M 50/533; H01M 4/02; H01M 4/78; H01M 10/0562; H01M 50/528

(52) U.S. Cl. CPC H01M 50/533; H01M 4/78; H01M 10/0562; H01M 50/528; H01M 2004/028

(57) ABSTRACT

Conventional batteries have room for improvement in terms of improving structural efficiency. The battery of the present disclosure comprises a power generating portion and a current collecting portion, and the current collecting portion comprises an electrode mixture. In the battery, for example, a layer comprising the electrode mixture in the current collecting portion may be bent together with a current collector.

### FIELD

The present application discloses a battery.

### BACKGROUND

PTL 1 discloses a battery, wherein a power generating portion and a terminal portion are electrically connected via a current collecting portion (collector foil portion). PTL 2 discloses an electrode for layered batteries, comprising a layered electrode portion and an electrode terminal portion.

### CITATION LIST

### Patent Literature

[PTL 1] Japanese Unexamined Patent Publication No. 2019-160525
[PTL 2] Japanese Unexamined Patent Publication No. 2019-207746

### SUMMARY

### Technical Problem

Conventional batteries have room for improvement in terms of improving structural efficiency (volumetric efficiency).

### Solution to Problem

The present application, as a means for achieving the above object, discloses the following plurality of aspects.

### <Aspect 1>

A battery, comprising a power generating portion and a current collecting portion, wherein
the current collecting portion comprises an electrode mixture.

### <Aspect 2>

The battery according to Aspect 1, wherein a layer comprising the electrode mixture is bent together with a current collector in the current collecting portion.

### <Aspect 3>

The battery according to Aspect 2, wherein the layer that is bent together with the current collector comprises a sagging portion.

### <Aspect 4>

The battery according to Aspect 2 or 3, wherein an end portion of the layer that is bent together with the current collector is protected by a resin.

### <Aspect 5>

The battery according to any of Aspects 1 to 4, wherein the power generating portion comprises a positive electrode active material layer, a solid electrolyte layer, and a negative electrode active material layer.

### <Aspect 6>

The battery according to any of Aspects 1 to 5, wherein the current collecting portion comprises a positive electrode mixture.

### Effects of Invention

The battery of the present disclosure has high structural efficiency.

### BRIEF DESCRIPTION OF DRAWINGS

FIG. 1 schematically shows a cross-sectional configuration of the battery. Features other than the power generating portion and the current collecting portion are omitted.

FIG. 2 schematically shows a cross-sectional configuration of the electrode body that constitutes the power generating portion and the current collecting portion.

### DESCRIPTION OF EMBODIMENTS

Hereinafter, one embodiment of the battery of the present disclosure will be described. However, the battery of the present disclosure is not limited to the following embodiment.

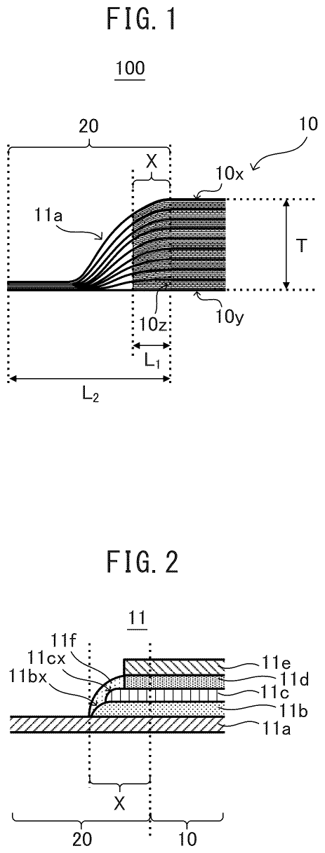

As shown in FIGS. 1 and 2, a battery 100 according to one embodiment comprises a power generating portion 10 and a current collecting portion 20. The current collecting portion 20 comprises an electrode mixture.

### 1. Power Generating Portion

The power generating portion 10 comprises an electrode body 11 as a power generating element. The power generating portion 10 may be formed by layering a plurality of electrode bodies 11.

As shown in FIG. 2, the electrode body 11 may comprise a first electrode current collector 11a, a first electrode active material layer 11b comprising a first electrode mixture, an electrolyte layer 11c, a second electrode active material layer 11d comprising a second electrode mixture, and a second electrode current collector 11e. In this case, the first electrode may be a positive electrode, and the second electrode may be a negative electrode. Alternatively, the first electrode may be a negative electrode, and the second electrode may be a positive electrode. One or both of the first electrode current collector 11a and the second electrode current collector 11e can protrude from a side face 10z of the power generating portion 10. In FIG. 1, an embodiment in which a plurality of first electrode current collector 11a protrude from a side face 10z of the power generating portion 10 is exemplified. The current collectors protruding from a side face 10z of the power generating portion 10 can be bent and bundled to each other to form a current collecting portion 20 described below.

The number of layers of electrode bodies 11 in the power generating portion 10 is not particularly limited. The power generating portion 10 may have a partially bipolar structure. In the power generating portion 10, an insulating layer may be provided between one electrode body 11 and another electrode body 11 to insulate the layered surfaces of the electrode bodies 11 from each other. As shown in FIG. 1, the plurality of electrode bodies 11 can be electrically connected to each other through the current collecting portion 20. For example, the plurality of electrode bodies 11 can be electrically connected to each other in parallel through the current collecting portion 20.

The power generating portion 10 may have one end face 10x on one end side in the layering direction of the layers described below, other end face 10y on other end side in the layering direction, and a side face 10z linking the one end face 10x and the other end face 10y. The side face 10z can be formed by the outer edges of the layers constituting the power generating portion 10. In the power generating portion 10, the side face 10z may have unevenness or gaps due to the layering area of each layer being different. The side face 10z may have a surface along the layering direction of the layers in the power generating portion 10. The current collecting portion 20 described below can be formed by current collectors 11a protruding from the side face 10z of the power generating portion 10. The power generating portion 10 as a whole, for example, may be plate-like or rectangular parallelepiped-like.

As shown in FIG. 1, the power generating portion 10 may have a thickness T in the layering direction of the layers. The thickness T, for example, may be 5 mm or more and 300 mm or less, or 10 mm or more and 50 mm or less.

Hereinafter, the case where the first electrode in the electrode body 11 constituting the power generating portion 10 is a positive electrode and the second electrode is a negative electrode will be exemplified. In one embodiment, the power generating portion 10 may comprise a positive electrode active material layer 11b, a solid electrolyte layer 11c, and a negative electrode active material layer 11d. Alternatively, in one embodiment, the power generating portion 10 may comprise a positive electrode active material layer 11b, a liquid electrolyte layer 11c, and a negative electrode active material layer 11d. Particularly, when the power generating portion 10 comprises a positive electrode active material layer 11b, a solid electrolyte layer 11c, and a negative electrode active material layer 11d, structural efficiency is likely to be further improved. The shape of the layering surface of each layer constituting the power generating portion 10, for example, may be rectangular.

### 1.1 Positive Electrode Active Material Layer

The positive electrode active material layer 11b comprises a positive electrode active material, and can further optionally comprise an electrolyte, a conductive aid, and a binder. The content of each of the positive electrode active material, electrolyte, conductive aid, and binder in the positive electrode active material layer 11b needs only to be appropriately determined according to target battery performance. For example, when the entirety (entire solid content) of the positive electrode active material layer 11b is 100% by mass, the content of the positive electrode active material may be 40% by mass or greater, 50% by mass or greater, or 60% by mass or greater, and may be 100% by mass or less or 90% by mass or less. The shape of the positive electrode active material layer 11b is not particularly limited, and for example, may be a sheet-like positive electrode active material layer 11b having a substantially flat surface. The thickness of the positive electrode active material layer 11b is not particularly limited, and for example, may be 0.1 μm or more or 1 μm or more, and may be 2 mm or less or 1 mm or less.

For the positive electrode active material, any publicly known positive electrode active material for batteries can be adopted. When lithium ions are adopted as carrier ions, the positive electrode active material, for example, may be a Li-containing oxide. Specifically, the positive electrode active material may be a Li-containing oxide comprising at least one element M, Li, and O. The element M, for example, may be at least one selected from Mn, Ni, Co, Al, Mg, Ca, Sc, V, Cr, Cu, Zn, Ga, Ge, Y, Zr, Sn, Sb, W, Pb, Bi, Fe, and Ti, or may be at least one selected from the group consisting of Mn, Ni, Co, Al, Fe, and Ti. More specifically, the Li-containing oxide as an additional positive electrode active material may be at least one selected from lithium cobaltate, lithium nickelate, lithium manganate, lithium nickel-cobalt oxide, lithium nickel-manganese oxide, lithium cobalt-manganese oxide, lithium nickel-cobalt-manganese oxide (Li_{1±α}NiₓCo_{y}Mn_{z}O_{2±δ} (for example, 0<x<1, 0<y<1, 0<z<1, and x+y+z=1)), spinel-based lithium compounds (such as heteroelement-substituted Li—Mn spinels having a composition represented by Li₁₊ₓMn_{2-x-y}M_{y}O₄ (where M is one or more selected from Al, Mg, Co, Fe, Ni, and Zn)), lithium nickel-cobalt-aluminum oxide (for example, Li₁₊ₓNiₚCo_{q}AlᵣO_{2±δ} (for example, p+q+r=1)), lithium titanate, and lithium metal phosphates (such as LiMPO₄, where M is one or more selected from Fe, Mn, Co, and Ni). The positive electrode active material may be of one type used alone, or may be of two or more types used in combination. The shape of the positive electrode active material needs only to be any general shape of positive electrode active materials for batteries. The positive electrode active material, for example, may be particulate. The positive electrode active material may be primary particles, or may be secondary particles of a plurality of agglomerated primary particles. The average particle size D50 of the positive electrode active material, for example, may be 1 nm or more, 5 nm or more, or 10 nm or more, and may be 500 μm or less, 100 μm or less, 50 μm or less, or 30 μm or less. Note that the average particle size D50 referred to in the present application is the 50% cumulative particle size (median diameter) in a volume-based particle size distribution determined by a laser diffraction/scattering method. On the surface of the positive electrode active material, a protective layer having ion-conducting properties may be formed. The protective layer having ion-conducting properties can comprise various ion-conducting compounds. The ion-conducting compound, for example, is at least one selected from ion-conducting oxides and ion-conducting halides.

The electrolyte that can be contained in the positive electrode active material layer 11b may be a solid electrolyte, may be a liquid electrolyte, or may be a combination thereof. Particularly, when the positive electrode active material layer 11b comprises a solid electrolyte, structural efficiency is likely to be improved.

For the solid electrolyte that can be contained in the positive electrode active material layer 11b, any publicly known solid electrolyte having carrier ion-conducting properties can be adopted. The solid electrolyte may be an inorganic solid electrolyte or a polymer electrolyte. Particularly, an inorganic solid electrolyte has excellent ion-conducting properties and thermal resistance. Examples of the inorganic solid electrolyte include oxide solid electrolytes, sulfide solid electrolytes, and inorganic solid electrolytes having ion-binding properties. Among inorganic solid electrolytes, sulfide solid electrolytes, and further thereamong, sulfide solid electrolytes comprising at least Li, S, and P as constituent elements have high performance. Alternatively, among inorganic solid electrolytes, solid electrolytes having ion-binding properties, and further thereamong, solid electrolytes comprising at least Li, Y, and a halogen (at least one of Cl, Br, I, and F) as constituent elements have high performance. The solid electrolyte may be amorphous, or may be crystalline. The solid electrolyte may be particulate. The average particle size D50 of the solid electrolyte, for example, may be 10 nm or more and 10 μm or less.

The liquid electrolyte (electrolyte solution) that can be contained in the positive electrode active material layer 11b is a liquid comprising carrier ions. The carrier ions, for example, may be lithium ions. The electrolyte solution may be a water-based electrolyte solution or a non-water-based electrolyte solution. The composition of the electrolyte solution is publicly known. The electrolyte solution may be a lithium salt dissolved in water or a non-water-based solvent. Examples of the non-water-based solvent include various carbonate-based solvents. Examples of the lithium salt include lithium amide and LiPF₆.

Examples of the conductive aid that can be contained in the positive electrode active material layer 11b include carbon materials such as vapor-grown carbon fiber (VGCF), acetylene black (AB), ketjen black (KB), carbon nanotube (CNT), and carbon nanofiber (CNF); and metal materials such as nickel, titanium, aluminum and stainless steel. The conductive aid, for example, may be particulate or fibrous, and the size thereof is not particularly limited. The conductive aid may be of one type used alone, or may be of two or more types used in combination.

Examples of the binder that can be contained in the positive electrode active material layer 11b include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, and polyimide (PI)-based binders. The binder may be of one type used alone, or may be of two or more types used in combination.

### 1.2 Electrolyte Layer

The electrolyte layer 11c is arranged between the positive electrode active material layer 11b and the negative electrode active material layer 11d. The electrolyte layer 11c comprises at least an electrolyte, and may further optionally comprise a binder. The contents of the electrolyte and the binder in the electrolyte layer 11c are not particularly limited. Alternatively, the electrolyte layer 11c may comprise a separator for retaining an electrolyte solution and preventing contact between the positive electrode active material layer 11b and the negative electrode active material layer 11d. The thickness of the electrolyte layer 11c is not particularly limited, and for example, may be 0.1 μm or more or 1 μm or more, and may be 2 mm or less or 1 mm or less.

The electrolyte contained in the electrolyte layer 11c needs only to be appropriately selected from among those (solid electrolytes and/or liquid electrolytes) exemplified as an electrolyte that can be contained in the positive electrode active material layer 11b described above. In addition, the binder that can be contained in the electrolyte layer 11c needs only to be appropriately selected from among those exemplified as a binder that can be contained in the positive electrode active material layer described above. The electrolyte and the binder may each be of one type used alone, or may be of two or more types used in combination. The separator needs only to be a commonly used separator in batteries, and examples include those made of resins such as polyethylene (PE), polypropylene (PP), polyester, and polyamide. The separator may be of a single-layer structure, or may be of a multilayer structure. Examples of separators having a multilayer structure can include separators of a PE/PP two-layer structure and separators of a PP/PE/PP or PE/PP/PE three-layer structure. The separator may consist of a nonwoven fabric such as cellulose fabric, resin nonwoven fabric, or glass-fiber nonwoven fabric.

### 1.3 Negative Electrode Active Material Layer

The negative electrode active material layer 11d comprises a negative electrode active material, and can further optionally comprise an electrolyte, a conductive aid, and a binder. The content of each of the negative electrode active material, electrolyte, conductive aid, and binder in the negative electrode active material layer 11d needs only to be appropriately determined according to target battery performance. For example, when the entirety (entire solid content) of the negative electrode active material layer 11d is 100% by mass, the content of the negative electrode active material may be 40% by mass or greater, 50% by mass or greater, or 60% by mass or greater, and may be 100% by mass or less or 90% by mass or less. The shape of the negative electrode active material layer 11d is not particularly limited, and for example, may be a sheet-like negative electrode active material layer 11d having a substantially flat surface. The thickness of the negative electrode active material layer 11d is not particularly limited, and for example, may be 0.1 μm or more or 1 μm or more, and may be 2 mm or less or 1 mm or less.

For the negative electrode active material, any publicly known negative electrode active material for batteries can be adopted. Of publicly known active materials, various materials having a low electric potential (charge and discharge potential) for storing and releasing carrier ions compared to the above positive electrode active material can be adopted. When lithium ions are adopted as carrier ions, as the negative electrode active material, for example, silicon-based active materials such as Si, Si alloys, and silicon oxides; carbon-based active materials such as graphite and hard carbon; various oxide-based active materials such as lithium titanate; and metallic lithium and lithium alloys can be adopted. The negative electrode active material may be of one type used alone, or may be of two or more types used in combination. The shape of the negative electrode active material needs only to be any general shape of negative electrode active materials for batteries. For example, the negative electrode active material may be particulate. The negative electrode active material particles may be primary particles, or may be secondary particles of a plurality of agglomerated primary particles. The average particle size D50 of the negative electrode active material particles, for example, may be 1 nm or more, 5 nm or more, or 10 nm or more, and may be 500 μm or less, 100 μm or less, 50 μm or less, or 30 μm or less. Alternatively, the negative electrode active material may be sheet-like (foil-like or membranous), such as a lithium foil. Specifically, the negative electrode active material layer 11d may consist of a sheet of negative electrode active material.

Examples of the electrolyte that can be contained in the negative electrode active material layer 11d include the solid electrolytes and electrolyte solutions described above and combinations thereof. The conductive aid that can be contained in the negative electrode active material layer 11d, for example, needs only to be appropriately selected from among those exemplified as a conductive aid that can be contained in the positive electrode active material layer described above. The binder that can be contained in the negative electrode active material layer 11d, for example, needs only to be appropriately selected from among those exemplified as a binder that can be contained in the positive electrode active material layer described above. The electrolyte, conductive aid, and binder may each be of one type used alone, or may be of two or more types used in combination.

### 1.4 Positive Electrode Current Collector

As shown in FIGS. 1 and 2, the battery 100 can comprise a positive electrode current collector 11a in contact with the positive electrode active material layer 11b. A portion of the positive electrode current collector 11a can protrude from the power generating portion 10 to form a current collecting portion 20. For the positive electrode current collector 11a, any general positive electrode current collector for batteries can be adopted. The positive electrode current collector 11a may have at least one shape selected from foil-like, plate-like, mesh-like, punched metal-like shapes and a foam. The positive electrode current collector 11a may be formed of a metal foil or a metal mesh. Particularly, a metal foil has excellent handleability. The positive electrode current collector 11a may consist of a plurality of foils. Metals constituting the positive electrode current collector 11a include at least one selected from Cu, Ni, Cr, Au, Pt, Ag, Al, Fc, Ti, Zn, Co, V, Mg, Pb, Ge, In, Sn, Zr, and stainless steel. Particularly, from the viewpoint of ensuring oxidation resistance, the positive electrode current collector 11a may comprise Al. The positive electrode current collector 11a may comprise, on the surface thereof, some coating layer for the purpose of adjusting resistance. For example, the positive electrode current collector 11a may have a carbon coating layer. The positive electrode current collector 11a may be a metal foil or substrate plated or vapor-deposited with a metal described above. When the positive electrode current collector 11a consists of a plurality of metal foils, there may be some layer between the plurality of metal foils. The thickness of the positive electrode current collector 11a is not particularly limited, and for example, may be 0.1 μm or more or 1 μm or more, and may be 1 mm or less or 100 μm or less.

### 1.5 Negative Electrode Current Collector

As shown in FIGS. 1 and 2, the battery 100 can comprise a negative electrode current collector 11 in contact with the negative electrode active material layer 11d. A portion of the negative electrode current collector 11 can protrude from the power generating portion 10 to form a current collecting portion separate from the above current collecting portion 20. For the negative electrode current collector 11, any general negative electrode current collector for batteries can be adopted. The negative electrode current collector 11e may be foil-like, plate-like, mesh-like, punched metal-like, or a foam. The negative electrode current collector 11e may be a metal foil or a metal mesh, and alternatively, may be a carbon sheet. Particularly, a metal foil has excellent handleability. The negative electrode current collector 11 may be formed of a plurality of foils or sheets. Metals constituting the negative electrode current collector 11 include at least one selected from Cu, Ni, Cr, Au, Pt, Ag, Al, Fe, Ti, Zn, Co, V, Mg, Pb, Ge, In, Sn, Zr, and stainless steel. Particularly, from the viewpoint of ensuring reduction resistance and the viewpoint of making alloying with lithium difficult, the negative electrode current collector 11 may comprise at least one metal selected from Cu, Ni, and stainless steel. The negative electrode current collector 11e may comprise, on the surface thereof, some coating layer for the purpose of adjusting resistance. For example, the negative electrode current collector 11e may have a carbon coating layer. The negative electrode current collector 11e may be an aluminum foil having a carbon coating layer. The negative electrode current collector 11e may be a metal foil or substrate plated or vapor-deposited with a metal described above. When the negative electrode current collector 11e consists of a plurality of metal foils, there may be some layer between the plurality of metal foils. The thickness of the negative electrode current collector 11e is not particularly limited, and for example, may be 0.1 μm or more or 1 μm or more, and may be 1 mm or less or 100 μm or less.

### 2. Current Collecting Portion

In the current collecting portion 20, a plurality of current collectors 11a protruding from the power generating portion 10 are electrically connected. For example, protrusions of the plurality of current collectors 11a are bent and bundled to each other, whereby the current collecting portion 20 can be formed.

In the prior art, in order to ensure capacity and insulate, an electrolyte layer is arranged on top of a sagging portion of the first electrode active material layer, and further thereon and inward from the sagging portion of the first electrode active material layer is formed a sagging portion of the second electrode active material layer. Additionally, in the prior art, in order to prevent the electrode active material layer from slipping off, the current collector (tab) is bent outward from the sagging portion to form the current collecting portion. As a result, structural efficiencies of the current collecting portion and around the sagging portions are worsened.

In the battery 100 according to the present embodiment, the current collecting portion 20 comprises an electrode mixture. “Electrode mixture” refers to a mixture constituting an electrode body 11, and for example, is at least one of a positive electrode mixture constituting the positive electrode active material layer 11b described above, a solid electrolyte mixture constituting the solid electrolyte layer when the electrolyte layer 11c is a solid electrolyte layer, and a negative electrode mixture constituting the negative electrode active material layer 11d. In one embodiment, the current collecting portion 20 may comprise a positive electrode mixture. In one embodiment, the current collecting portion 20 may comprise a negative electrode mixture. When the current collecting portion 20 comprises an electrode mixture, structural efficiency of the current collecting portion 20 can be improved, compared to when the current collecting portion 20 does not comprise an electrode mixture.

As shown in region X in FIGS. 1 and 2, in the battery 100, end portions of the positive electrode active material layer 11b, electrolyte layer 11c, and/or negative electrode active material layer 11d extend into the current collecting portion 20, and the positive electrode active material layer 11b, electrolyte layer 11c, and/or negative electrode active material layer 11d extend to the bent portions of the current collectors 11a in the current collecting portion 20. In other words, in the battery 100, the layers comprising the electrode mixture (positive electrode active material layer 11b and/or negative electrode active material layer 11d) in the current collecting portion 20 may be bent together with the current collectors 11a.

In the battery 100, the layers (positive electrode active material layer 11b, electrolyte layer 11c, and/or negative electrode active material layer 11d) that are bent together with the current collectors 11a may comprise a sagging portion. In FIG. 2, an embodiment in which the positive electrode active material layer 11b and the electrolyte layer 11c have sagging portions 11bx and 11cx, respectively, is exemplified. However, the embodiment of the sagging portion is not limited thereto. “Sagging portion” refers to a sloped portion formed at an end portion of a layer when forming the layer by an application method (refer to, for example, Japanese Unexamined Patent Publication (Kokai) No. 2015-220216 and Japanese Unexamined Patent Publication (Kokai) No. 2014-096302). A sagging portion of the layer is generally thinner than portions other than the sagging portion of the layer. Therefore, the sagging portion of the layer is more easily bent than portions other than the sagging portion of the layer.

As shown in FIG. 2, in the battery 100, end portions of the layers (positive electrode active material layer 11b, electrolyte layer 11c, and/or negative electrode active material layer 11d) that are bent together with the current collectors 11a may be protected by a resin 11f. Consequently, the end portions of the layers are less likely to peel or slip off even when the layers are bent together with the current collectors 11a. The type of the resin 11f is not particularly limited, and various curing resins can be adopted. The resin 11f may be formed at the same time as the layers 11b to 11d, may be formed before the layers 11b to 11d, or may be formed after the layers 11b to 11d.

As shown in FIG. 1, the current collecting portion 20 may comprise an electrode mixture within a range from a side face 10z of the power generating portion 10 to a length L₁. The current collecting portion 20 may have a length L₂ from the side face 10z of the power generating portion 10 to the tip (the portion most distant from the side face 10z of the power generating portion 10 before connecting to a terminal) of the current collecting portion 20. The length L₁, for example, may be 1.0 mm or more and 10.0 mm or less. The length L₂, for example, may be 1.1 mm or more and 100 mm or less. The ratio L₁/L₂ between the length L₁ and the length L₂, for example, may be 0.1 or greater and less than 1. When the dimensions of the current collecting portion 20 are within these ranges, structural efficiency of the battery 100 is likely to be further improved.

### 3. Additional Features

The battery 100, in addition to the above features, may comprise any general feature of a battery, for example, terminals or an outer packaging. Specifically, for the battery 100, the above current collecting portion 20 may be connected to terminals, and the above features may be housed inside an outer packaging. Any publicly known terminal can be adopted as terminals of the battery. Any publicly known outer packaging can be adopted as the outer packaging of the battery. In addition, a plurality of batteries 100 may be optionally connected electrically and optionally stacked to form a battery pack. In this case, the battery pack may be housed inside a publicly known battery case. Examples of shapes of the battery 100 can include those of coin-type and laminate-type. The battery 100 may be a secondary battery. The battery 100 may be an all-solid battery.

### 4. Manufacturing Method of Battery

The battery 100 can be manufactured, for example, as follows.

(1) A positive electrode mixture constituting a positive electrode active material layer is dispersed in a solvent to obtain a positive electrode layer slurry. The solvent used in this case is not particularly limited, and water and various organic solvents can be used. The positive electrode layer slurry is applied onto a surface of a positive electrode current collector using a doctor blade, followed by drying, whereby a positive electrode active material layer is formed on the surface of the positive electrode current collector to obtain a positive electrode.

(2) A negative electrode mixture constituting a negative electrode active material layer is dispersed in a solvent to obtain a negative electrode layer slurry. The solvent used in this case is not particularly limited, and water and various organic solvents can be used. The negative electrode layer slurry is applied onto a surface of a negative electrode current collector using a doctor blade, followed by drying, whereby a negative electrode active material layer is formed on the surface of the negative electrode current collector to obtain a negative electrode.

(3) Layers are layered so that an electrolyte layer (solid electrolyte layer or separator) is sandwiched by the negative electrode and the positive electrode to obtain an electrode body comprising, in the order of, a negative electrode current collector, a negative electrode active material layer, an electrolyte layer, a positive electrode active material layer, and a positive electrode current collector.

(4) A plurality of electrode bodies are layered to obtain a power generating portion. In this case, a plurality of current collectors are set to protrude from a side face of the power generating portion.

(5) The current collectors protruding from the power generating portion are each bent together with the electrode mixture, and the plurality of current collectors are bundled to each other to form a current collecting portion.

(6) Additional members such as terminals are attached to the current collecting portion as needed. The power generating portion and the current collecting portion are housed in a battery case. In the case of an electrolyte solution battery, the battery case is filled therein with an electrolyte solution, each portion is immersed in the electrolyte solution, and the battery case is sealed, thereby obtaining a battery. Note that in the case of an electrolyte solution battery, prior to housing each portion in the battery case, the electrolyte solution may be contained in the negative electrode active material layer, the separator, and the positive electrode active material layer.

### 5. Application

The battery 100 has a wide range of applications. For example, the battery 100 can be suitably used in at least one type of vehicle selected from hybrid vehicle (HEV), plug-in hybrid vehicle (PHEV), and electric vehicle (BEV). Specifically, the technique of the present disclosure also has an aspect as a vehicle comprising the above battery 100 of the present disclosure.

### REFERENCE SIGNS LIST

100 battery
   10 power generating portion
   10x one end face in layering direction
   10y other end face in layering direction
   10z side face
      11 electrode body
         11a first electrode current collector
         11b first electrode active material layer
         11bx sagging portion
         11c electrolyte layer
         11cx sagging portion
         11d second electrode active material layer
         11e second electrode current collector
         11f resin
   20 current collecting portion

1. A battery, comprising a power generating portion and a current collecting portion, wherein
the current collecting portion comprises an electrode mixture.

2. The battery according to claim 1, wherein
a layer comprising the electrode mixture is bent together with a current collector in the current collecting portion.

3. The battery according to claim 2, wherein
the layer that is bent together with the current collector comprises a sagging portion.

4. The battery according to claim 2, wherein
an end portion of the layer that is bent together with the current collector is protected by a resin.

5. The battery according to claim 1, wherein
the power generating portion comprises a positive electrode active material layer, a solid electrolyte layer, and a negative electrode active material layer.

6. The battery according to claim 1, wherein
the current collecting portion comprises a positive electrode mixture.
